(19) United States
(12) Patent Application Publication
(10) Pub. No.: US 2007/0227593 A1
(43) Pub. Date: Oct. 4, 2007

(54) Air relief valve

(75) Inventors: James-Wallace Belford, Kibbutz Magal (IL); Erez Govrin, Kibbutz Magal (IL)

Correspondence Address: NAIH & ASSOCIAIES, PLLC, Sixth Floor, 1030 15th Street, N.W., Washington, DC, 20005, US

(73) Assignee: NETAFIM LTD., Tel Aviv (IL)

(21) Appl. No.: 11/395,156

(22) Filed: Apr. 3, 2006

(51) Int. Cl. F16K 24/04

(52) U.S. Cl. 137/202

(57) ABSTRACT

An air relief valve for use with an irrigation pipe. The valve comprises a base attached to the wall of the pipe, a vent extending from the interior of the pipe to the exterior of the pipe, a shutoff mechanism, and a water level sensor disposed within the pipe. The vent has an inlet adapted to face the interior of the pipe and an outlet adapted to face the exterior of the pipe. The shutoff mechanism is pivotally articulated to the base between an opening position thereof wherein air can exit the pipe via the vent and a closing position thereof wherein air is prevented from exiting the pipe via the vent. The shutoff mechanism is responsive to the water level sensor to selectively pivot between the opening and the closing positions.

### FIELD OF THE INVENTION

This invention relates to air relief valves, particularly those adapted for use with irrigation pipes.

### BACKGROUND OF THE INVENTION

In large irrigation pipes operating at low pressures, it is common for air to enter therein and become entrapped. This air may be present before the filling and remain trapped, or be present at a much lower volume in water of a higher pressure in the system and expand to a greater volume on entering the low pressure irrigation pipe. Obstructions such as a partially open gate valve may produce cavitations which tend to further expand the entrapped air when the pressure is lowered.

The air tends to accumulate in large elongated bubbles at points along the pipe which are at higher elevations than adjacent portions (so called local peaks). Since these air pockets cannot move along the pipe, the effective diameter of the pipe in the location thereof is reduced. This may result in turbulent flow of the water in the pipe, as well as in surging and water hammer. Damage or rupture of the pipe may result.

In order to deal with trapped air, it is known in the art to provide one or more of several types of valves and/or vents, such as air relief/vacuum relief valves, continuous acting air vents (with or without vacuum relief), and pressure relief valves. Such valves/vents are provided, for example, by McMaster-Carr, under the name Air-Release Valve.

### SUMMARY OF THE INVENTION

According to first aspect of the present invention, there is provided an air relief valve comprising a base adapted for attachment to the wall of an irrigation pipe, a vent extending through the base from an interior side thereof, adapted to face the interior of the pipe to an exterior side thereof, adapted to face the exterior of the pipe, a water level sensor adapted to be disposed within the pipe at least during use of the vent, and a shutoff mechanism responsive to the water level sensor to open the vent, thereby allowing air to exit the pipe via the vent at least during use, and to close the vent to prevent the air from exiting the pipe via the vent at least during use. The vent has an inlet at the interior side thereof and an outlet at the exterior side thereof, and the shutoff mechanism is movable by the water level sensor between an opening position thereof wherein the inlet of the vent is open for the air from the pipe to pass via the outlet of the vent to the exterior of the pipe, and a closing position thereof wherein the inlet of the vent is closed.

The water level sensor may have two ends and may be pivotally connected at one end thereof to the base so as to pivot between a first, opening position in which the other end of the sensor is spaced from the wall of the pipe to a first distance, and a second, closing position in which the other end of the pipe is located at a second distance from said wall, which is smaller than said first distance. In this case it may be advantageous if the sensor is connected to the base in such orientation that its second end is located at a location along the pipe downstream of its first end. The valve may comprise an indicium to indicate the orientation at which it should be mounted to the wall of the pipe, to ensure above orientation of the sensor.

The water level sensor may be in the form of a floatation device adapted to float on water and to be movable between said first and second positions in consequence with the change of the level of water in the pipe.

According to one embodiment, the vent is in the form of a tube protruding from the base to the interior of the pipe and having a thin-walled portion, and the shutoff mechanism is constituted by the tube being bendable to allow air to exit the pipe via the tube any time except for when the tube is bent to prevent the air from exiting the pipe. In this case, the base may include a rigid tube support portion to support the thin-walled portion of the tube, which may comprise a stationary section, a pivoting section and a bending section therebetween, allowing the pivoting section to pivotally articulate relative to the stationary section, and thereby bend the tube in the area of said bending section, to bring it to said closing position.

If in this embodiment the water level sensor is in the form of a floatation device, such device may be attached to the pivoting section of the rigid tube support portion of the base to cause this part to pivot and bend the tube in the area of the said bending section, when the water in the pipe reaches a predetermined level.

According to another embodiment, the vent is in the form of a through-going bore formed in the base and the shutoff mechanism is in the form of a stopper in translational association with the water level sensor, i.e., it is movable by the water level sensor between said opening position in which the stopper is spaced from the inlet of the vent and said closing position in which stopper sealingly bears against the inlet of the vent. The stopper may be formed from a viscoelastic material. The shutoff mechanism may be mounted to the water level sensor or formed as part thereof.

According to a second aspect of the present invention, there is provided an air relief valve comprising a base adapted for attachment to the wall of the pipe, a vent extending through the base from an interior side thereof, adapted to face the interior of the pipe, to or beyond an exterior side thereof, adapted to face the exterior of the pipe, and a water level sensor, said vent being deformable responsive to the water level sensor, between an opening position allowing, at least during use, air to exit the pipe via the vent, and a closing position to prevent, at least during use, the air from exiting the pipe via the vent.

The vent may be in the form of a bendable tube to allow air to exit the pipe via the tube any time except for when the tube is bent to prevent the air from exiting the pipe.

In one embodiment, the tube may protrude from the base to the interior of the pipe and may have a thin-walled portion. In this case, the base may include a rigid tube support portion to support said thin-walled portion of the tube, which may comprise a stationary section, a pivoting section and a bending section therebetween, allowing the pivoting section to pivotally articulate relative to the stationary portion, and thereby bend the tube in the area of said bending section, to bring it to said closing position. If in this embodiment the water level sensor is in the form of a floatation device, such device may be attached to the pivoting section of the rigid tube support portion of the base to cause this part to pivot and bend the tube in the area of the said bending portion, when the water in the pipe reaches a predetermined level.

In another embodiment, the base may comprise a hollow chamber, with said tube disposed therein. The tube may be disposed in the chamber in a bent position and have a stationary tube section, a pivoting tube section and a bending tube section therebetween, the pivoting section being adapted to pivotally articulate relative to the stationary section by the deformation of the bending section. If in this embodiment the water level sensor is in the form of a floatation device, such device may be also disposed within the chamber to bear against the pivoting tube section, thereby causing the tube to bend when the water in the pipe reaches a predetermined level.

The water level sensor does not necessarily have to be in the form of a floatation device but may be in any other form capable of bending the tube.

According to a further aspect of the present invention, there is provided a direction indicator for use in a valve to allow proper orientation thereof inside an irrigation pipe.

According to a still further aspect of the present invention, there is provided an irrigation pipe comprising a float and an opening located in proximity thereto, the pipe being adapted for introduction into an irrigation main.

The irrigation main may be a flexible pipe.

The opening may be formed such that is passes through the float or in the pipe substantially adjacent thereto.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a perspective view of an air release valve according to one embodiment of the present invention;

FIG. 2 is a front view of the valve illustrated in FIG. 1;

FIG. 3 is a close-up view of the area indicated at ‘A’ in FIG. 1, from a slightly different perspective;

FIGS. 4A and 4B illustrate the valve of FIG. 1 installed in a pipe, during different states of fill thereof;

FIGS. 4C and 4D are cross-sectional views of a tube, being part of the valve illustrated in FIG. 1, taken along line II-II in FIG. 2, in open and closed positions, respectively;

FIG. 5 is a cross-sectional view of an air release valve, in an open position, according to another embodiment of the present invention;

FIG. 6 is a top view of a base of the valve illustrated in FIG. 5;

FIG. 7 is a partial back view of the valve illustrated in FIG. 5;

FIG. 8 is a cross-sectional view of the valve illustrated in FIG. 5, in a closed position;

FIGS. 9A and 9B illustrate the valve of FIG. 5 installed in a pipe, during different states of fill thereof;

FIG. 10 illustrate an air release valve, according to a further embodiment of the present invention;

FIG. 11 is a cross-sectional view of the valve illustrated in FIG. 10, taken along line IV-IV;

FIG. 12 is a cross-sectional view of the valve illustrated in FIG. 10, taken along line VII-VII;

FIG. 13 is a cross-sectional view of the valve illustrated in FIG. 10, taken along line IV-IV, shown during use in a closed position; and

FIGS. 14A and 14B are cross sectional views of an irrigation pipe according to two examples of a simplified arrangement of the present invention.

### DETAILED DESCRIPTION OF EXEMPLARY EMBODIMENTS

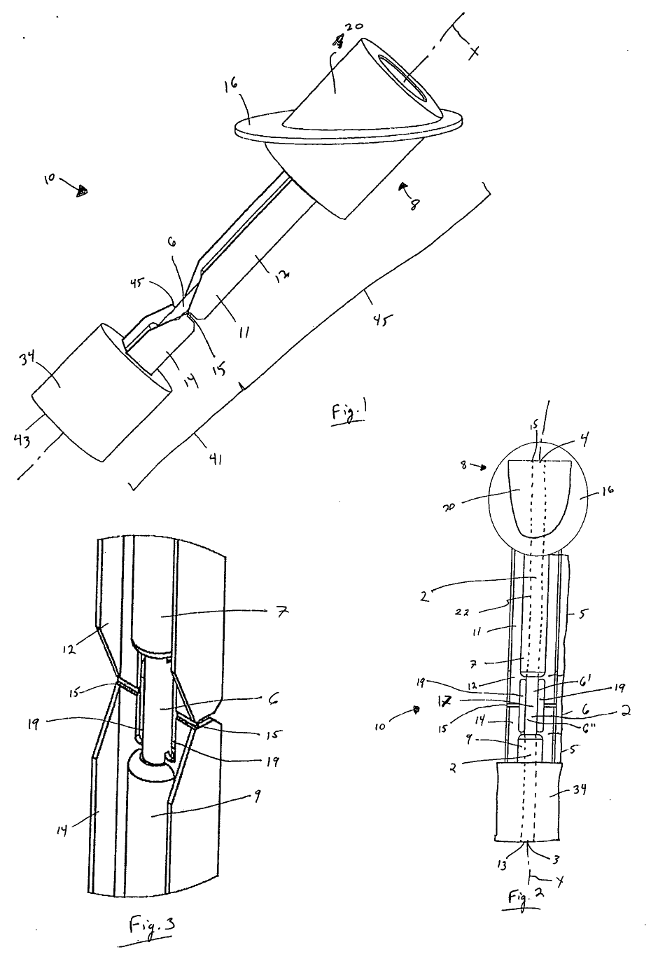

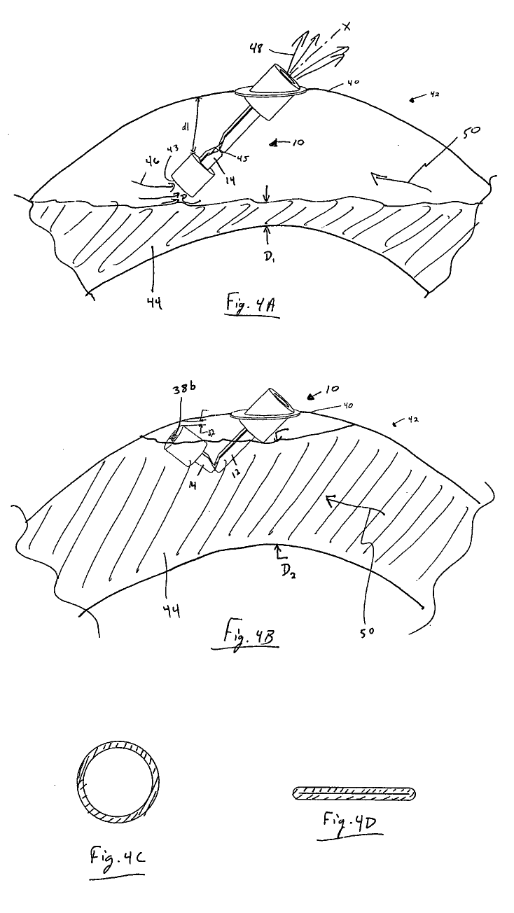

FIGS. 1, 2 and 3 illustrate one example of an air relief valve, generally designated at 10, in an open position. The valve 10 has a longitudinal axis X and is adapted for installation in the wall of an irrigation pipe with the axis X forming an angle with the wall, as shown in FIGS. 4A and 4B. The pipe may be any known flexible pipe, such as that disclosed in US 2004-0222321 A1 to the present applicant, the Detailed Description of which is incorporated herein by reference.

As better seen in FIG. 2, the valve 10 comprises a vent tube 2 having an inlet section 3, an outlet section 4, and an intermediate section 5 therebetween with a thin-walled section 6. The thin-walled section 6 has an external diameter essentially less than that of the adjacent thick-walled portions 7 and 9 of the intermediate section 5 of the vent tube.

The valve further comprises a rigid tube support portion 11 supporting the intermediate section 5 of the vent tube 2, a base portion, generally indicated at 8, mounted on the outlet section 4 of the vent tube 2, and a float 34 mounted on the inlet portion 3 of the vent tube 2. The vent tube 2 together with the rigid tube support portion 4 may be produced by injection molding, with the base section 8 and the float 34 being molded over the respective inlet and outlet sections 3 and 4 thereof. The base section and the float are made of a material which is substantially non-absorbent and is less dense than water.

The base portion 8 comprises a flange 16, adapted for being pressed to the inner surface of the wall of the irrigation pipe, and a cylindrical end-piece 20 adapted to protrude from the outer surface of the wall, when the valve is installed therein and to be held by user's hand or tool during the installation, as will be explained in more detail later.

As best seen in FIG. 2, the vent tube 2 has a tubular passageway 22 extending all along the valve and having an inlet 13 in the float 34 and an outlet 15 in the cylindrical end-piece 20.

The rigid tube support portion 11 comprises a stationary section 12, a free section 14, and a bending section 15 therebetween in the form of a living hinge, allowing the free section 14 to be pivotally articulated relative to the stationary section 12 about an axis perpendicular to the longitudinal axis X of the valve. The stationary section 12 of the rigid supporting portion 11 accommodates the thick-walled portion 7 and a part 6′ of the thin-walled section 6 of the vent tube 2, and it merges with the base portion 8. The free section 14 of the rigid supporting portion 11 accommodates the thick-walled portion 9 and a part 6″ of the thin-walled section 6 of the vent tube 2, and it merges with the float 34. The bending section 15 of the rigid support portion 11 is formed with aperture 19 extending along the thin-walled portion 6 of the vent tube so that, when the free section 14 is articulated relative to the stationary section 12 thereof, the thin-walled section 6 may deform outwardly when bent in the vicinity of bend-area 17 wherein parts 6′ and 6″ merge.

FIG. 4A illustrates the valve 10 in its open position, mounted to the wall 40 of an irrigation pipe 42, for instance in a local peak thereof (where trapped air will accumulate). This may be accomplished either before the pipe is filled or after. In the latter case, the water supply should be shut off before the installation. A hole, having a diameter smaller that that of the end-piece 20, is formed in the pipe. Before insertion, the valve 10 may be bent and re-straightened, in order to create an initial bend-line in the bending section 15 of the rigid tube support portion 11 of the vent tube 2. The valve 10 is inserted through the hole, free-portion 14 first. The flange 16 is forced through the hole, and then the valve 10 is pulled back so that the flange bears against the interior side of the wall of the pipe. The internal pressure of the irrigation pipe 42 creates a seal between the flange 16 and the interior side of the wall of the pipe.

Upon filling of the pipe, as seen in FIG. 4A, a large quantity of air may accumulate above the water 44. In the absence of any venting means, the effective diameter of the pipe in the location of the air is D₁. In this state, the free portion 14 of the valve 10 hangs, keeping the vent tube 2 in an open position. Air can therefore exit the pipe 42 by entering the inlet 13 of the vent tube 2 along the path indicated by arrows 46, and exiting the outlet 15 thereof along the path indicated by arrows 48. As seen in FIG. 4B, as the air is vented, the level of water 44 rises, which raises the float 34, pivoting the free portion 14 thereof, and bending the thin-walled section 6 of the vent tube 2 until it seals itself by kinking (i.e., the section 6 of the tube 2 deforms along the bend-area 17 thereof until the cross sectional shape of the tube becomes linear, as illustrated in FIGS. 4C and 4D). The effective diameter of the pipe in the location of the air is thereby increased to D₂.

It will be appreciated that the vent tube 2 is to be made of a material which can withstand such bending without rupture, such as from polypropylene or polyethylene.

During use of the pipe, it is normal for additional air to become trapped therein. As this occurs, the level of water in the vicinity of the valve 10 lowers, causing the free portion 14 thereof, and the float 34 carried thereby, to fall. The vent tube 2 opens, allowing excess air to escape. As the air escapes, the level of water rises, resealing the tube.

Thus, in operation, the float 34 with the free portion 14 constitutes a water level sensor 41 of the valve, which has a free distal end 43 and a proximal end 45 with which the sensor is pivotally connected to the stationary portion 12, the latter together with the base portion 8, constituting the valve's base 45. The water level sensor 41 thus pivots between a first, opening position in which the distal end 43 thereof is spaced from the wall 40 of the pipe 42 to a first distance d1, and a second, closing position in which the distal end 43 is located at a second distance d2 from the wall 40, which is smaller than the first distance d1.

In order to safeguard against the water preventing the free portion 14 from pivoting upward, the valve 10 may be installed such that the distal end 43 of its water level sensor 41 is downstream from its proximal end 45, as seen in FIGS. 4A and 4B (with the direction of water flow being indicated by arrow 50).

It will be appreciated that it is not sufficient that the water level sensor 41 be designed so that the buoyant force thereof when submerged in water is sufficient to raise itself, but the buoyant force must also sufficient to bend the vent tube 2, and keeping the distal end 43 of the water level sensor above the surface of the water.

FIG. 5 illustrates another example of an air relief valve, generally indicated at 100. The valve comprises a base body 102 and a water level sensor in the form of a float 104 having a distal end 103 spaced from the body 102 and a proximal end 107 at which the float is pivotally articulated to the body 102 about axle 106.

The body 102 is adapted to be attached to the wall of a pipe. It comprises a vent 108 open to a key-receiving portion 110. As best seen in FIG. 6, the key receiving portion 110 is in the form of a regular hexagon, and is adapted to receive therein a standard allen-type key wrench. The body 102 further comprises a float support 112 adapted to receive therewithin the axle 106. As seen in FIG. 7, the float support 112 comprises two legs 112a and 112b, adapted to receive therebetween the float 104. It will be appreciated that while the float 104 is illustrated in FIG. 7 as having a narrow portion adapted to be received within the legs 112a, 112b and a wide portion, the entire length of the float may be of the same thickness as the portion received within the legs.

The float 104 is adapted to float on water, and comprises a stopper 114 on an upper surface thereof. The stopper 114 is located such that when the float 104 is in a horizontal position against the bottom of the base 102 (see FIG. 8), it bears against the bottom of the vent 108, thereby sealing it. It is made from a material adapted to hermetically seal the vent 108, such as a viscoelastic material. The stopper 104 may be a distinct piece securely held to the float 104, or it may be integrally formed therewith. Alternatively, the float 104 may be covered with a tight-fitting sheath (not shown) comprising a portion adapted to serve as the stopper.

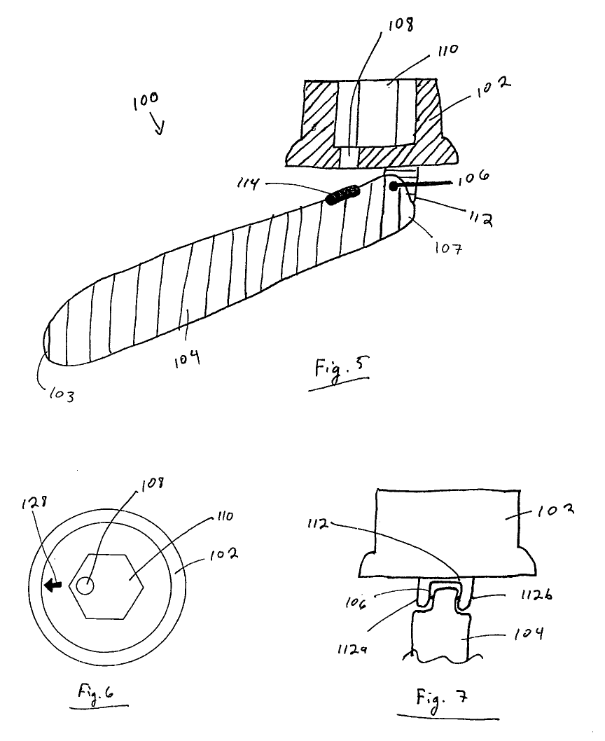

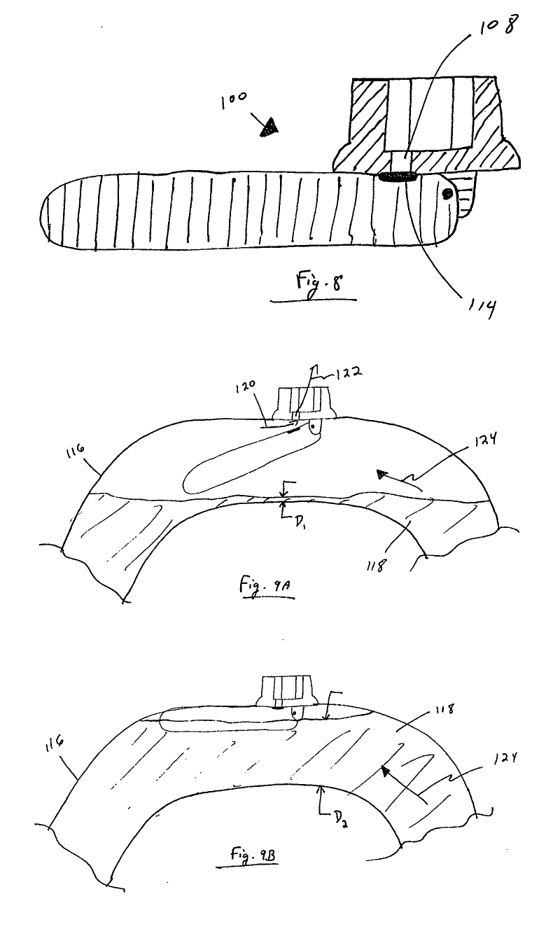

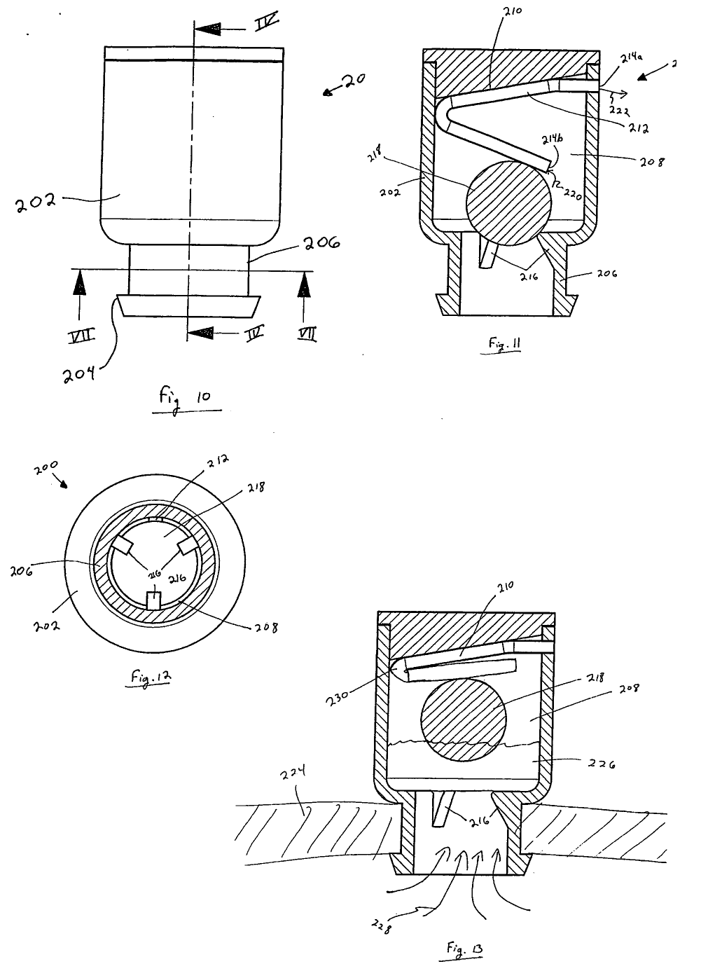

In operation, as illustrated in FIGS. 9A and 9B, the valve 100 is mounted to the wall of an irrigation pipe 116, for instance in a local peak thereof (where trapped air will accumulate). Upon filling of the pipe, as seen in FIG. 9A, a large quantity of air accumulates above the water 118. In the absence of any venting means, the effective diameter of the pipe in the location of the air is D₁. In this state, the float 104 hangs, keeping the vent 108 open to the pipe. Air can therefore exit the pipe 116 by entering the vent 108 along the path indicated by arrows 120, and exiting along the path indicated by arrows 122. As seen in FIG. 9B, as the air is vented, the level of water 116 rises, which raises the float 104, and pivoting it until it seals the vent 108. The effective diameter of the pipe in the location of the air is thereby increased to D₂.

During use of the pipe, it is normal for additional air to become trapped therein. As this occurs, the level of water in the vicinity of the valve 100 lowers, causing the float 104 the fall. The vent 108 is opened, allowing excess air to escape. As the air escapes, the level of water rises, causing the float 104 to rise and recluse the vent 108.

In order to safeguard against the normal flow of water, and especially the in-rush of new water during filling of the pipe, from causing the float 104 from pivoting upward, the valve 100 may be installed such that the distal end 103 of the float 104 is located downstream from the proximal end thereof, as seen in FIGS. 9A and 9B (with the direction of water flow being indicated by arrow 124). In order to align the valve 100 after it is installed, an allen-type key wrench may be inserted in the key receiving portion 110 in order to rotate the valve. It will be appreciated that the key receiving portion 110 may be replaced by any other feature which can receive therein a tool adapted to imparting a torque, such as a recess (not shown) adapted to receive a Phillips-head or flat-head screwdriver, or a custom tool. Reverting to FIG. 6, an indicium 128, such as in the form of an arrow, may be provided to indicate the preferred direction of installation (as illustrated in FIG. 6, the indicium indicates the downstream direction of the pipe).

Among the advantages of the above examples is the possibility of being mounted on a lay-flat type pipe, having relatively thin walls, after having been deployed and still have a sensor to float within the pipe.

FIG. 10 illustrates a third embodiment of an air release valve, generally designated at 200. The valve 200 comprises a housing having a main portion 202, a shoulder 204, and a neck 206 therebetween. The neck 206 is adapted to receiver the wall of the pipe when installed.

As seen in FIG. 11, the main portion 202 of the housing defines therein a hollow main chamber 208, which is bounded at the top by an upper wall 210. A bent flexible conduit 212, constituting a vent, is provided within the chamber 208, having a proximal, stationary portion 213, bearing against the wall 210, a distal, free portion 215 hanging within the main chamber 208, and a bending portion 217 therebetween. The conduit is made such that when it is bent at the bending portion 217, air or other fluids cannot pass the location of bending. This may be accomplished, e.g., by constructing the conduit 212 from a thin-walled material with polymer chains oriented along the length thereof.

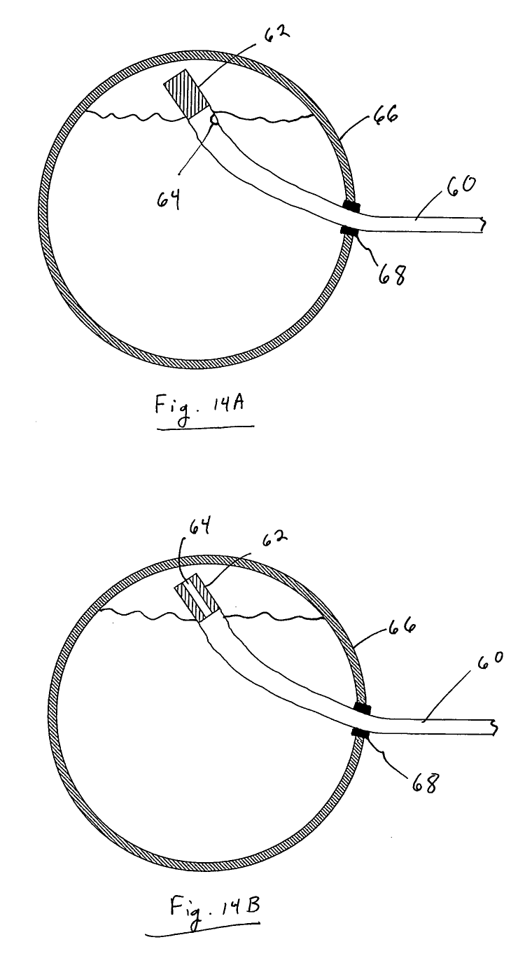

The conduit 212 is open at a proximal end 214a thereof to the exterior of the valve 200, and at a distal end 214b thereof to the interior of the main chamber 208. The main chamber 208 is open at the bottom. Three legs 216 are provided there, protruding inwardly from the interior surface of the neck 206 (see FIG. 12).

A water level sensor in the form of a ball 218, adapted to float on water, is provided within the main chamber 208. The ball 218 is of a diameter such that it cannot pass between the three legs 216. When the ball 218 rests in a neutral position on the legs 216, the hanging portion of the conduit 212 bears against it. Air is thus free to exit the valve by entering the conduit 212 at its distal end 214b, e.g., along the path indicated by arrow 220, and exiting the conduit, as indicated by arrow 222, from the proximal end 214a thereof.

As illustrated in FIG. 13, the valve 200 may receive a pipe wall 224 on its neck 206 for mounting thereon. The valve 200 is place at a point on the pipe which is at a local peak thereof (where trapped air will accumulate). As the air accumulates, it exits the valve 200 as described above. When most of the air has been released, water 226 begins to enter the main chamber 208 of the valve, as indicated by arrows 228, lifting the ball 218. The hanging portion of the conduit 212 rises with the ball 218, causing it to bend further, thereby sealing itself at the point of bending 230.

During use of the pipe, it is normal for additional air to become trapped therein. As this occurs, the level of water in the vicinity of the valve 200 lowers, causing the ball 218, and as a result the hanging portion of the conduit 212, to fall. The conduit 212 opens, allowing excess air to escape. As the air escapes, the level of water rises, causing the ball 218 to rise, raising the hanging portion of the conduit 212 until it closes itself.

Some of the advantages of the above examples may further be realized in a simplified arrangement, as illustrated in FIGS. 14A and 14B. An irrigation pipe 60, having outlets (not shown) as known in the art, such as drippers, sprinklers, etc., is provided at one end with a float 62 and an opening 64 close to (as in FIG. 14A) or integral with (as in FIG. 14B) the float. The pipe 60 is inserted into an irrigation main 66 at a location where it is determined that air may or has accumulated. A connector 68 is provided in order to ensure than no water leaks out at the point of connection.

During use, the float 62 keeps the opening 64 at or near the top of the level of the water within the irrigation main 66. As air accumulates within the irrigation main 66 in the vicinity of the pipe 60, it is released via the pipe and exits through the openings. When all of the air has been thus dispelled, water continues to flow through the pipe 60 to the openings.

Those skilled in the art to which this invention pertains will readily appreciate that numerous changes, variations and modifications can be made without departing from the scope of the invention mutatis mutandis.

1. An air relief valve comprising a base adapted for attachment to the wall of an irrigation pipe, a vent extending through the base from an interior side thereof, adapted to face the interior of the pipe to an exterior side thereof, adapted to face the exterior of the pipe, a movable water level sensor adapted to be disposed within the pipe, at least during use of the vent, and a shutoff mechanism responsive to the water level sensor to open the vent, thereby allowing air to exit the pipe via the vent at least during use, and to close the vent to prevent the air from exiting the pipe via the vent at least during use.

2. An air relief valve to claim 1, wherein the vent has an inlet at the interior side thereof and an outlet at the exterior side thereof, and the shutoff mechanism is movable by the water level sensor between an opening position thereof wherein the inlet of the vent is open for the air from the pipe to pass via the outlet of the vent to the exterior of the pipe, and a closing position thereof wherein the inlet of the vent is closed.

3. An air relief valve according to claim 1, wherein the water level sensor has two ends and is pivotally connected at one end thereof to the base so as to pivot between a first, opening position in which the other end of the sensor is spaced from the wall of the pipe to a first distance, and a second, closing position in which the other end of the sensor is located at a second distance from said wall, which is smaller than said first distance.

4. An air relief valve according to claim 3, wherein said sensor is connected to the base in such orientation that its second end is located at a location along the pipe downstream of its first end.

5. An air relief valve according to claim 4, comprising an indicium to indicate the orientation at which it should be mounted to the wall of the pipe.

6. An air relief valve according to claim 1, wherein the vent is in the form of a tube protruding from the base to the interior of the pipe and having a thin-walled portion, and the shutoff mechanism is constituted by the tube being bendable to allow air to exit the pipe via the tube any time except for when the tube is bent to prevent the air from exiting the pipe.

7. An air relief valve according to claim 6, wherein the base includes a rigid tube support portion to support the thin-walled portion of the tube.

8. An air relief valve according to claim 7, wherein the rigid tube support portion comprises a stationary section, a pivoting section and a bending section therebetween, allowing the pivoting section to pivotally articulate relative to the stationary section, and thereby bend the tube in the area of said bending section, to bring it to said closing position.

9. An air relief valve according to claim 8, wherein the water level sensor is in the form of a floatation device attached to the pivoting section of the rigid tube support portion of the base to cause this section to pivot and bend the tube in the area of the said bending section, when the water in the pipe reaches a predetermined level.

10. An air relief valve according to claim 1, wherein the vent is in the form of a through-going bore formed in the base and the shutoff mechanism is in the form of a stopper in translational association with the water level sensor, the stopper being movable by said sensor between said opening position and said closing position.

11. An air relief valve according to claim 10, wherein the shutoff mechanism is mounted to or formed as part of the water level sensor.

12. An air relief valve according to claim 10, wherein the vent is formed within the base.

13. An air relief valve according to claim 10, wherein the stopper is made from a viscoelastic material.

14. An air relief valve according to claim 10, wherein the water level sensor is an elongated floatation device.

15. An air relief valve according to claim 1, wherein the valve is adapted to receive therewithin a tool.

16. An air relief valve comprising a base adapted for attachment to the wall of an irrigation pipe, a vent extending through the base from an interior side thereof, adapted to face the interior of the pipe, to or beyond an exterior side thereof, adapted to face the exterior of the pipe, and a water level sensor, said vent being deformable responsive to the water level sensor, between an opening position allowing, at least during use, air to exit the pipe via the vent, and a closing position to prevent, at least during use, the air from exiting the pipe via the vent.

17. An air relief valve according to claim 16, wherein the vent is in the form of a bendable tube to allow air to exit the pipe via the tube any time except for when the tube is bent to prevent the air from exiting the pipe.

18. An air relief valve according to claim 17, wherein the tube protrudes from the base to the interior of the pipe and has a thin-walled portion.

19. An air relief valve according to claim 18, wherein the base includes a rigid tube support portion to support said thin-walled portion of the tube.

20. An air relief valve according to claim 19, wherein said rigid tube support portion comprises a stationary section, a pivoting section and a bending section therebetween, allowing the pivoting section to pivotally articulate relative to the stationary portion, and thereby bend the tube in the area of said bending section, to bring it to said closing position.

21. An air relief valve according to claim 20, wherein the water level sensor is in the form of a floatation device attached to the pivoting section of the rigid tube support portion of the base to cause this part to pivot and bend the tube in the area of the said bending portion, when the water in the pipe reaches a predetermined level.

22. An air relief valve according to claim 17, wherein said base comprises a hollow chamber, with said tube disposed therein.

23. An air relief valve according to claim 22, wherein said the tube is disposed in the chamber in a bent position and have a stationary tube section, a pivoting tube section and a bending tube section therebetween, the pivoting section being adapted to pivotally articulate relative to the stationary section by the deformation of the bending section.

24. An air relief valve according to claim 23, wherein the water level sensor is in the form of a floatation device disposed at least partially within the chamber to bear against the pivoting tube section, thereby causing the tube to bend when the water in the pipe reaches a predetermined level.

25. An air relief valve according to claim 16, wherein the water level sensor extends in a direction substantially downstream of the base.

26. A direction indicator for use in a valve to allow proper orientation thereof inside an irrigation pipe.

27. An irrigation pipe comprising a float and an opening located in proximity thereto, said pipe being adapted for introduction into an irrigation main.

28. An irrigation pipe according to claim 27, wherein the irrigation main is a flexible pipe.

29. An irrigation pipe according to claim 27, wherein the opening is formed within the pipe substantially adjacent the float.

30. An irrigation pipe according to claim 27, wherein the opening is formed such that it passes through the float.
